(19) United States
(12) Patent Application Publication
(10) Pub. No.: US 2008/0228318 A1
(43) Pub. Date: Sep. 18, 2008

(54) Device and Method of Controlling Dispenser For Refrigerator

(76) Inventors: Jin-Sug Roo, Gyeongsangnam-do (KR); Kyung-Ah Choi, Seoul City (KR); Mi-Soon Ahn, Seoul City (KR); Chang-Woo Song, Seoul City (KR)

Correspondence Address: BIRCH STEWART KOLASCH & BIRCH, PO BOX 747, FALLS CHURCH, VA, 22040-0747, US

(21) Appl. No.: 12/065,236

(22) PCT Filed: Sep. 4, 2006
(86) PCT No.: PCT/KR2006/003502

§ 371 Date: Feb. 28, 2008

(30) Foreign Application Priority Data
Sep. 2, 2005 (KR) 10-2005-0081714
Sep. 4, 2006 (KR) 10-2006-0084695

(51) Int. Cl. G06F 17/00; B67D 5/06; B67D 5/62

(52) U.S. Cl. 700/231; 222/23; 222/146.6; 62/389

(57) ABSTRACT

The present invention relates to an device and method for controlling a dispenser for a refrigerator. The present invention comprises an input unit including a switch for generating a dispensing-start signal to initiate the dispensing of ice, water or both through the dispenser, a dispensing button for inputting an operation signal to allow ice, water or both to be selectively dispensed through the dispenser, and dispensing amount-setting and dispensing time-setting buttons for inputting an operation signal to set a dispensing time and amount per unit time of ice, water or both through the dispenser, respectively; and a control unit for receiving the dispensing-start signal from the switch and controlling ice, water or both corresponding to the dispensing amount per unit time inputted through the dispensing amount-setting button to be dispensed through the dispenser for the dispensing time inputted through the dispensing time-setting button in response to the operation signal inputted through the dispensing button. According to the present invention, there is an advantage in that ice and/or water can be selectively dispensed more conveniently.

### TECHNICAL FIELD

The present invention relates to a refrigerator, and more particularly, to an device and method for controlling a dispenser for a refrigerator which can dispense ice and/or water to the outside without opening/closing a refrigerator door.

### BACKGROUND ART

In general, a refrigerator is an electric appliance for storing foods freshly at a low temperature. Recently, in order to satisfy various desires of consumers, a refrigerator equipped with a dispenser capable of dispensing water or ice to the outside has come into the market.

FIG. 5 is a front view showing a refrigerator equipped with a related art dispenser, and FIG. 6 is a sectional view showing the dispenser shown in FIG. 5.

As shown in the figures, a freezing chamber door 3 and a refrigerating chamber door 5 are installed to a main body 1 of the refrigerator in which freezing and refrigerating chambers are formed. The freezing and refrigerating chamber doors 3 and 5 are pivoted to allow the freezing and refrigerating chambers to be opened or closed, respectively, in such a manner that one ends thereof are rotated forward and backward about the other ends.

Furthermore, a dispenser 10 is provided at a portion of a front surface of the freezing chamber door 3. The dispenser 10 is provided with a depressed portion 11 in which an ice container and cup can be accommodated. In the depressed portion 11 is provided an operating lever 13 which is pushed toward an inner surface of the depressed portion 11 by the ice container or cup such that a dispensing amount of ice or water can be adjusted by the operating lever. The operating lever 13 is installed such that its lower end can be rotated forward and backward about its upper end.

As shown in FIG. 6, a switch SW1 is provided on the inner surface of the dispenser 10 corresponding to the operation lever 13. The switch SW1 is turned on by means of a backward motion of the operation lever 13 such that ice or water can be supplied to the ice container or cup placed in the depressed portion 11. In fact, ice is dispensed through an ice duct 16A and water is dispensed through a dispensing port 15B.

In addition, an operation panel 17 is provided on a portion of a front surface of the dispenser 10 above the depressed portion 11. The operation panel 17 comprises a display unit 18 for displaying information on the refrigerator operation to the outside and an input unit 19 provided with a plurality of operation buttons such as an ice dispensing button and a water dispensing button through which operation signals for dispensing ice and water are inputted, respectively.

The related art dispenser so configured dispenses ice or water in the following manner.

First, a user actuates the ice or water dispensing button provided on the input unit 19 to determine whether ice or water is dispensed. In such a state, if the user pushes the operation lever 13 toward the inner surface of the depressed portion 11 using the ice container or cup, the switch SW1 is turned on. Further, a control unit (not shown) can adjust a dispensing amount of ice or water according to a condition where the operation lever 13 is pushed, e.g. a period of time when the operation lever 13 is pushed.

However, such a related art dispenser for a refrigerator has the following problems.

As described above, the input unit 19 includes only the ice and water dispensing buttons. Therefore, there is a problem in that ice and water cannot be dispensed simultaneously or sequentially by only a single operation by the user.

Further, if the user wishes to take a predetermined amount of ice or water, he/she should push the operation lever 13 continuously for a predetermined period of time. Thus, an effort of the user to dispense ice or water may be made unnecessarily.

### DISCLOSURE OF INVENTION

### Technical Problem

The present invention is conceived to solve the aforementioned problems. An object of the present invention is to provide an device and method for controlling a dispenser for a refrigerator which can dispense ice and water by only a single operation.

Another object of the present invention is to provide an device and method for controlling a dispenser for a refrigerator which can dispense ice and/or water by a simpler operation.

### Technical Solution

According to an aspect of the present invention for achieving the objects, there is provided an device for controlling a dispenser for a refrigerator, comprising: an input unit for inputting an operation signal to allow ice, water or both to be selectively dispensed through the dispenser; and a control unit for controlling ice, water or both to be dispensed through the dispenser in response to the operation signal inputted through the input unit.

If an operation signal for allowing ice and water to be dispensed is inputted through the input unit, the control unit allows the water and ice to be simultaneously dispensed.

If an operation signal for allowing ice and water to be dispensed is inputted through the input unit, the control unit allows the water and ice to be sequentially dispensed.

The operation signal for allowing ice, water or both to be selectively dispensed is inputted through a single or multiple dispensing buttons provided in the input unit.

The dispensing button includes: an ice dispensing button for inputting an operation signal for allowing ice to be dispensed through the dispenser; a water dispensing button for inputting an operation signal for allowing water to be dispensed through the dispenser; and an ice/water dispensing button for inputting an operation signal for allowing ice and water to be dispensed through the dispenser.

Meanwhile, the present invention provides an device for controlling a dispenser for a refrigerator, comprising: an input unit for inputting a dispensing time and amount per unit time of ice, water or both dispensed through the dispenser; and a control unit for controlling ice, water or both corresponding to the dispensing amount per unit time inputted through the input unit to be dispensed through the dispenser for the dispensing time inputted through the input unit.

A setting completion signal and an operation signal for setting the dispensing time and amount per unit time of ice, water or both are inputted through a dispensing amount-setting button, a dispensing time-setting button and a setting completion button provided on the input unit.

The control unit controls a driving rate of a motor for providing a driving force to transfer ice to the dispenser in accordance with the dispensing amount per unit time inputted through the input unit and controls a driving time of the motor in accordance with the dispensing time inputted through the input unit.

The control unit controls an opening degree of a valve, through which water is transferred to the dispenser, in accordance with the dispensing amount of water per unit time inputted through the input unit and controls an opening time of the valve in accordance with the dispensing time inputted through the input unit.

The control unit receives a dispensing-start signal from a switch provided at a portion of the dispenser when the switch is turned on, and controls the dispensing of ice, water or both through the dispenser to be initiated.

The switch is turned on as an operation knob provided at a portion of the dispenser is pushed down.

Meanwhile, the present invention provides an device for controlling a dispenser for a refrigerator, comprising: an input unit including a switch for generating a dispensing-start signal to initiate the dispensing of ice, water or both through the dispenser, a dispensing button for inputting an operation signal to allow ice, water or both to be selectively dispensed through the dispenser, and dispensing amount-setting and dispensing time-setting buttons for inputting an operation signal to set a dispensing time and amount per unit time of ice, water or both through the dispenser, respectively; and a control unit for receiving the dispensing-start signal from the switch and controlling ice, water or both corresponding to the dispensing amount per unit time inputted through the dispensing amount-setting button to be dispensed through the dispenser for the dispensing time inputted through the dispensing time-setting button in response to the operation signal inputted through the dispensing button.

In a case where the dispensing time and amount per unit time of ice, water or both dispensed through the dispenser are inputted through the input unit, the control unit controls the dispenser in an automatic mode in which ice, water or both corresponding to the dispensing amount per unit time inputted through the input unit is dispensed for the dispensing time inputted through the input unit when the dispensing-start signal is transmitted as the switch is turned on; whereas in a case where the dispensing time and amount per unit time of ice, water or both dispensed through the dispenser are not inputted through the input unit, the control unit controls the dispenser in a manual mode in which the selected ice, water or both corresponding to the initially set dispensing amount per unit time is dispensed only a period of time while the dispensing-start signal is transmitted as the switch is turned on.

The control unit controls the dispenser in the manual mode except when an operating signal for setting the dispensing time or the dispensing-start signal is inputted through the input unit within a predetermined time in a state where the dispensing amount per unit time of ice, water or both is inputted through the input unit or when the dispensing-start signal is inputted through the input unit within a predetermined time in a state that the dispensing time and amount per unit time of ice, water or both are inputted through the input unit.

The operation signal for selecting one of the manual and automatic modes is inputted through the input unit; and the control unit controls the dispenser either in the automatic mode in which the selected ice, water or both corresponding to the dispensing amount per unit time inputted through the input unit is dispensed for the dispensing time inputted through the input unit when the dispensing-start signal is transmitted as the switch is turned on in a case where an operation signal for selecting the automatic mode is inputted through the input unit or in the manual mode in which the selected ice, water or both corresponding to the initially set dispensing amount per unit time is dispensed only a period of time while the dispensing-start signal is transmitted as the switch is turned on in a case where an operation signal for selecting the manual mode is inputted through the input unit.

In a state where the operation signal for selecting the dispensing of water and ice is inputted through the input unit, both of ice and water can be dispensed in the automatic or manual mode or one of the ice and water is dispensed in the automatic mode but the other is dispensed in the manual mode.

In a state where an operation signal for selecting the automatic mode is inputted through the input unit, the control unit controls the dispenser in the manual mode except if an additional operation signal is not inputted through the input unit within a predetermined time.

An operation signal for selecting any one of the automatic and manual modes is inputted through a mode-setting button provided on the input unit.

Meanwhile, the present invention provides a method of controlling a dispenser for a refrigerator, comprising the steps of: (a) inputting an operation signal through an input unit to select the dispensing of ice, water or both; (b) inputting a dispensing-start signal through the input unit to initiate the dispensing of ice, water or both; and (c) controlling, by the control unit, the selected ice, water or both to be dispensed through the dispenser in response to the dispensing-start signal received from the input unit.

In step (c), when the dispensing of ice and water is selected in step (a), the control unit controls the selected water and ice to be simultaneously dispensed.

In step (c), when the dispensing of ice and water is selected in step (a), the control unit controls the selected water and ice to be sequentially dispensed.

Meanwhile, the present invention provides a method of controlling a dispenser for a refrigerator, comprising the steps of: (a) inputting an operation signal through an input unit for selecting the dispensing of ice, water or both; (b) inputting an operation signal through the input unit to set a dispensing time and amount per unit time of ice, water or both; and (c) controlling, by the control unit, the selected ice, water or both corresponding to the dispensing amount per unit time inputted through the input unit to be dispensed through the dispenser for the dispensing time inputted through the input unit.

Step (b) comprises the steps of: (b1) inputting an operation signal through the input unit to set the dispensing amount per unit time of ice, water or both; (b2) inputting an operation signal through the input unit to set the dispensing time of ice, water or both; and (b3) inputting an operation signal through the input unit to complete the setting of the dispensing time and amount per unit time of ice, water or both.

Step (c) comprises the steps of: (c1) inputting an operation signal through the input unit to generate a dispensing-start signal; and (c2) controlling, by the control unit, the selected ice, water or both corresponding to the dispensing amount per unit time inputted through the input unit to be dispensed through the dispenser for the dispensing time inputted through the input unit in response to the dispensing-start signal received from the input unit.

In step (C2), the control unit controls a driving rate of a motor for providing a driving force to transfer ice to the dispenser in accordance with the dispensing amount of ice per unit time inputted through the input unit and controls a driving time of the motor in accordance with the dispensing time inputted through the input unit.

In step (C2), the control unit controls an opening degree of a valve, through which water is transferred to the dispenser, in accordance with the dispensing amount of water per unit time inputted through the input unit and controls an opening time of the valve in accordance with the dispensing time inputted through the input unit.

In step (c2), the control unit controls the dispenser either in the automatic mode in which the selected ice, water or both corresponding to the dispensing amount per unit time inputted through the input unit is dispensed for the dispensing time inputted through the input unit when the dispensing-start signal is transmitted in a case where the dispensing time and amount per unit time of ice, water or both are inputted through the input unit within a predetermined time, or in the manual mode in which the ice, water or both corresponding to the initially set dispensing amount per unit time is dispensed only a period of time while the dispensing-start signal is transmitted from the input unit except in a case where the dispensing time and amount per unit time of ice, water or both are inputted through the input unit within the predetermined time.

Meanwhile, the present invention provides a method of controlling a dispenser for a refrigerator, comprising the steps of: (a) inputting an operation signal through an input unit to select the dispensing of ice, water or both; (b) inputting an operation signal through the input unit to select any one of automatic and manual modes; (c) inputting a dispensing time and amount per unit time of ice, water or both through the input unit; and (d) controlling the dispenser, by the control unit, such that in a case where an operation signal for selecting the automatic mode is inputted through the input unit, the selected ice, water or both corresponding to the dispensing amount per unit time inputted through the input unit is dispensed for the dispensing time inputted through the input unit when the dispensing-start signal is transmitted from the input unit, or that the selected ice, water or both corresponding to the initially set dispensing amount per unit time is dispensed only a period of time while the dispensing-start signal is transmitted in a case where an operation signal for selecting the manual mode is inputted through the input unit.

In step (b), in a case where the operation signal for selecting the dispensing of water and ice is inputted through the input unit, both of ice and water can be dispensed in the automatic or manual mode or one of the ice and water is dispensed in the automatic mode but the other is dispensed in the manual mode.

Step (c) comprises the steps of: (c1) inputting an operation signal through the input unit to set the dispensing amount per unit time of ice, water or both; (c2) inputting an operation signal through the input unit to set the dispensing time of ice, water or both; and (c3) inputting an operation signal through the input unit to complete the setting of the dispensing time and amount per unit time of ice, water or both.

Step (d) comprises the steps of: (d1) inputting an operation signal through the input unit to generate a dispensing-start signal; and (d2) controlling the dispenser, by the control unit, such that in a case where an operation signal is inputted through the input unit to select the automatic mode, the selected ice, water or both corresponding to the dispensing amount per unit time inputted through the input unit is dispensed through a dispenser for the dispensing time inputted through the input unit when the dispensing-start signal is transmitted from the input unit or that the selected ice, water or both corresponding to the initially set dispensing amount per unit time is dispensed through the dispenser only for a period of time while an operating signal is inputted through the input unit to generate the dispensing-start signal in a case where an operation signal is inputted through the input unit to select the manual mode.

Step (d) is further comprised the step of (d3) controlling the dispenser in the manual mode by the control unit except in a case where the dispensing time and amount per unit time of ice, water or both are inputted through the input unit within a predetermined time, when the operation signal is inputted through the input unit to select the automatic mode.

### ADVANTAGEOUS EFFECTS

According to the present invention, there is an advantage in that ice and/or water can be selectively dispensed in a simpler manner.

### BRIEF DESCRIPTION OF DRAWINGS

FIG. 1 is a front view showing a portion of a front surface of a refrigerator door provided with an device for controlling a dispenser for a refrigerator according to a preferred embodiment of the present invention;

FIG. 2 is a sectional view showing the dispenser constituting the embodiment shown in FIG. 1;

FIG. 3 is a block diagram schematically illustrating the configuration of the embodiment shown in FIG. 1;

FIG. 4 is a flowchart illustrating a process of controlling a dispenser based on a method of controlling a dispenser for a refrigerator according a preferred embodiment of the present invention;

FIG. 5 is a front view showing a refrigerator equipped with a related art dispenser; and

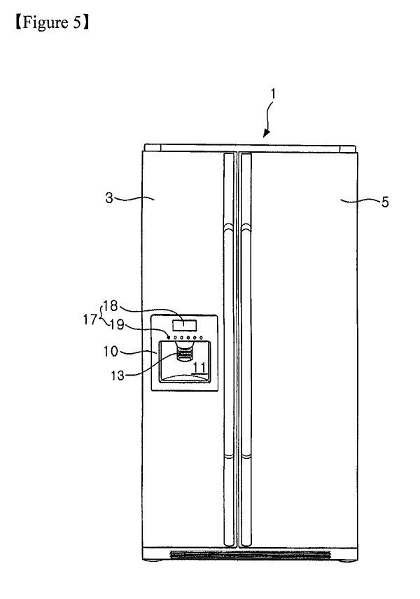

FIG. 6 is a sectional view showing the dispenser shown in FIG. 5.

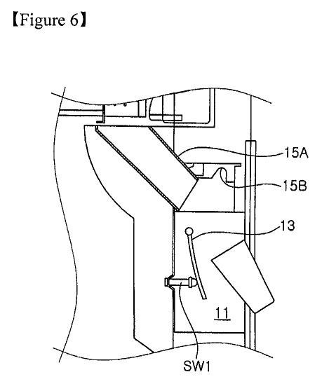

### BEST MODE FOR CARRYING OUT THE INVENTION

Hereinafter, an device and method for controlling a dispenser for a refrigerator according to a preferred embodiment of the present invention will be described in more detail with reference to accompanying drawings.

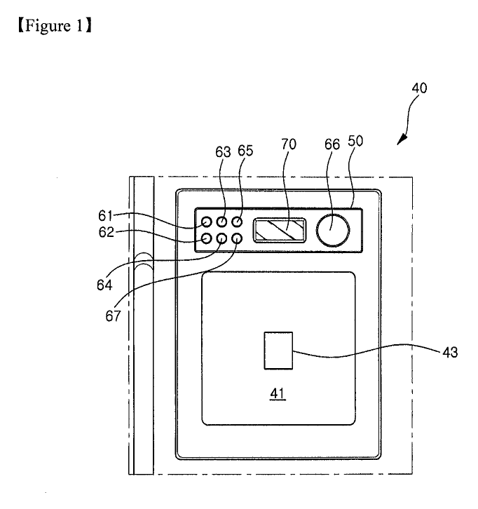

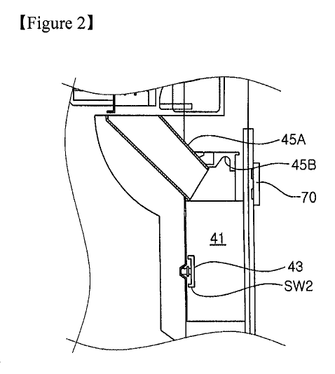

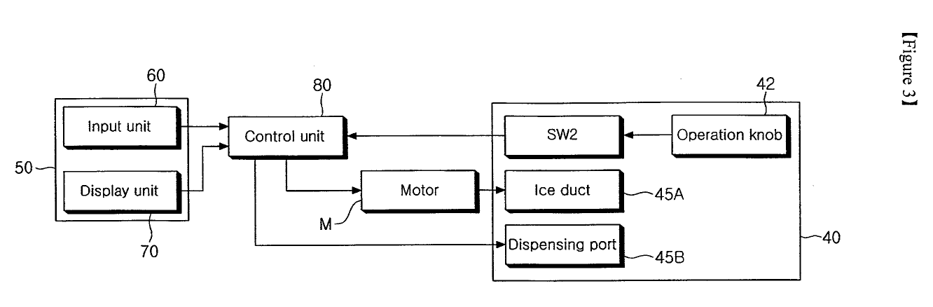

FIG. 1 is a front view showing a portion of a front surface of a refrigerator door provided with an device for controlling a dispenser for a refrigerator according to a preferred embodiment of the present invention, FIG. 2 is a sectional view showing the dispenser constituting the embodiment shown in FIG. 1, and FIG. 3 is a block diagram schematically illustrating the configuration of the embodiment shown in FIG. 1.

As shown in the figures, a dispenser 40 is installed on a front surface of a refrigerator door. The dispenser 40 allows a user to take water or ice out from the outside in a state where the refrigerator door is not opened. The dispenser 40 is provided with a depressed portion 41 in which an ice container, cup or the like can be placed.

An operation knob 43 is provided on an inner surface of the depressed portion 41 which is parallel with the front surface of the refrigerator door. The operation knob 43 is installed to be movable in a direction perpendicular to the inner surface of the depressed portion 41.

A switch SW2 is provided on the inner surface of the depressed portion 41 corresponding to the operation knob 43 and is turned when the operation knob 43 is pushed toward the inner surface of the depressed portion 41. The switch SW2 receives a signal for starting dispensing ice and/or water and transmits the received signal to a control unit 80 to be described below.

An ice duct 45A is provided on a rear portion of the ceiling of the depressed portion 41 such that its one end communicates with the depressed portion 41. Further, a dispensing port 45B is provided on a portion of the ceiling of the depressed portion 41 in front of the one end of the ice duct 45A. Ice made in an ice maker (not shown) is dispensed through the ice duct 45A while water is dispensed through the dispensing port 45B. The one end of the ice duct 45A and the dispensing port 45B are preferably sized such that they fall within a general sectional area of the ice container, cup or the like.

An operation panel 50 is provided on a front surface of the dispenser 40 corresponding to a position above the depressed portion 41. The operation panel 50 comprises an input unit 60 through which an operation signal for selectively operating the refrigerator or dispenser 40 is inputted, and a display unit 70 on which information on a setting or operating state of the dispenser 40 according to the operation signal inputted through the input unit 60 is displayed.

The input unit 60 includes an ice dispensing button 61, a water dispensing button 62 and an ice/water dispensing button 63. The ice dispensing button 61, the water dispensing button 62 and the ice/water dispensing button 63 are alternatively operated to receive an operation signal for determining whether to dispense ice and/or water. That is, if the ice or water dispensing button 61 or 62 is operated, it is determined that ice or water will be dispensed. Further, the ice/water dispensing button 63 is operated, it is determined that the ice and water will be dispensed simultaneously or sequentially. Although it has been described in the illustrated embodiment that the ice dispensing button 61, the water dispensing button 62 and the ice/water dispensing button 63 are individually provided, only a single dispensing button can be used to selectively dispense water, ice or both. That is, ice is dispensed if a single dispensing button is operated once, and water is dispensed if the dispensing button is operated twice. Further, both of ice and water are dispensed if the dispensing button is operated three times.

In addition, the input unit 60 includes a dispensing amount-setting button 64, a dispensing time-setting button 65 and a setting completion button 66. The dispensing amount-setting button 64 is used to input an operation signal for setting an amount of ice and/or water dispensed per unit time, and the dispensing time-setting button 65 is used to input an operation signal for setting a dispensing time of ice and/or water. The setting completion button 66 is used to input an operation signal for completing the setting of the amount of ice and/or water dispensed per unit time and the dispensing time inputted through the dispensing amount-setting button 64 and the dispensing time-setting button 65.

Further, the input unit 60 is further provided with a mode-setting button 67. The mode-setting button 67 is used to select an automatic or manual mode. Here, the automatic or manual mode is determined according to the operation method of the operation knob 43 which turns on the switch SW2 to dispense ice and/or water.

In other words, if an automatic mode is selected through the mode-setting button 67, ice and/or water is dispensed in accordance with the dispensing amount per unit time for the dispensing time, which are already set, regardless of an additional turning-on operation of the switch SW2, so long as the switch SW2 is turned on by the operating knob 43. That is, if the automatic mode is selected through the mode-setting button 67, ice and/or water is dispensed in accordance with the already set dispensing amount per unit time so long as the dispensing-start signal is transmitted to the control unit 80 by the switch SW2.

On the other hand, if the manual mode is selected through the mode-setting button 67, ice and/or water is dispensed only while the switch SW2 is turned on by the operation knob 43. That is, if the manual mode is selected through the mode-setting button 67, ice and/or water is dispensed only while the dispensing-start signal is transmitted to the control unit 80 by the switch SW2.

In the meantime, after any one of the ice dispensing button 61, the water dispensing button 62 and the ice/water dispensing button 63 has been selected such that ice, water or both are dispensed, the mode selection is performed by the mode-setting button 67. Accordingly, the mode which can be selected by the mode-setting button 67 is classified into the following six cases, i.e. two cases where ice is dispensed in the automatic and manual modes after the ice dispensing button 61 has been operated, two cases where water is dispensed in the automatic and manual modes after the water dispensing button 62 has been operated, and two cases where both of water and ice are dispensed identically or differently in the automatic and manual modes after the water/ice dispensing button 63 has been operated. Therefore, ice, water or both can be dispensed in the automatic or manual mode according to the number of times the mode-setting button 67 is operated. For example, in a case where the ice dispensing button 61 has been operated, ice is dispensed in the automatic mode if the mode-setting button 67 is operated once, and ice is dispensed in the manual mode if the mode-setting button 67 is operated twice. Likewise, in a state where the water dispensing button 62 has been operated, water is dispensed in the automatic mode if the mode-setting button 67 is operated once, and water is dispensed in the manual mode if the mode-setting button 67 is operated twice. Similarly, in a state where the ice/water dispensing button 63 has been operated, ice and water are dispensed in the automatic mode if the mode-setting button 67 is operated once, ice is dispensed in the automatic mode but water is dispensed in the manual mode if the mode-setting button 67 is operated twice, ice is dispensed in the automatic mode but water is dispensed in the manual mode if the mode-setting button 67 is operated three times, and both of ice and water are dispensed in the manual mode if the mode-setting button 67 is operated four times.

A state where any one of the ice dispensing button 61, the water dispensing button 62 and the ice/water dispensing button 63 has been alternatively operated is displayed on the display unit 70. Further, the dispensing amount of ice and/or water per unit time which has been set by operating the dispensing amount-setting button 64, the dispensing time of ice and/or water which has been set by operating the dispensing time-setting button 65 and the automatic or manual mode selected by operating the mode-setting button 67 are displayed on the display unit 70.

As shown in FIG. 3, the control unit 80 is provided to control the operation of the dispenser 40 in accordance with an operational signal inputted through the input unit 80 and to display a setting and operating state of the dispenser 40 in accordance with an operational signal inputted through the input unit 80 on the display unit 70. The control unit 80 can be integrated into a central processing unit (not shown) which controls the whole operation of the refrigerator or be provided individually to control the dispenser 40.

When any one of the ice dispensing button 61, the water dispensing button 62 and the ice/water dispensing button 63 is alternatively operated, only ice or water is dispensed or both of ice and water are dispensed simultaneously or sequentially under the control of the control unit 80. Further, the control unit 80 allows ice and/or water corresponding to the dispensing amount of ice and/or water per unit time set by the dispensing amount-setting button 64 to be dispensed for the dispensing time of ice and/or water set by the dispensing time-setting button 65. For example, the control unit 80 controls a driving rate and time of an ice-moving means (not shown) for transferring ice produced in the ice maker (not shown) to the dispenser 40 through the ice duct 45A, so that ice corresponding to the dispensing amount per unit time set by the dispensing amount-setting button 64 can be dispensed through the dispenser 40 for a period of time set by the dispensing time-setting button 65. In addition, the control unit 80 controls a valve (not shown) which causes water to be dispensed through the dispensing port 45B, so that water corresponding to the dispensing amount per unit time set by the dispensing amount-setting button 64 can be dispensed through the dispenser 40 for the period of time set by the dispensing time-setting button 65.

Further, the control unit 80 allows ice and/or water to be dispensed either for only a period of time for which the dispensing-start signal is transmitted from the switch SW2 according to the mode (i.e., the automatic or manual mode) selected by the mode-setting button 67 or regardless of the signal-transmitting period of time. In addition, in a case where the automatic mode is selected by the mode-setting button 67, it is controlled such that the current automatic mode is converted into the manual mode by the control unit 80 if an operation signal is not inputted through the input unit 60 for a predetermined period of time. This function of the control unit is provided to prevent ice and/or water from being dispensed in accordance with a condition set by the previous user, regardless of the intention of the current user. For example, in a state where the automatic mode is selected by the mode-setting button 67, the current automatic mode is set to be converted into the manual mode by the control unit 80 if an operation signal is not inputted through the input unit 60 for 5 minutes.

Hereinafter, a process of controlling a dispenser using an device for controlling the refrigerator dispenser according a preferred embodiment of the present invention will be described in more detail with reference to the accompanying drawings.

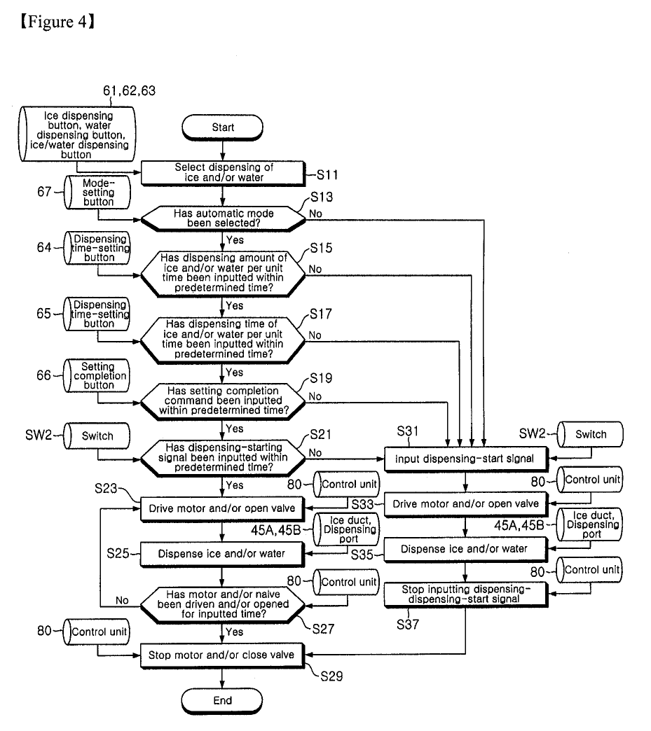

FIG. 4 is a flowchart illustrating a process of controlling the dispenser based on a method of controlling the refrigerator dispenser according the preferred embodiment of the present invention.

As shown in the figure, a user operates any one of the ice dispensing button 61, the water dispensing button 62 and the ice/water dispensing button 63 such that ice, water or both can be dispensed (S11). Then, the user operates the mode-setting button 67 to select any one of the automatic and manual modes (S13). Here, the automatic mode is a mode where ice, water or both corresponding to the dispensing amount per unit time set by the user is dispensed for the set dispensing time, and the manual mode is a mode where ice, water or both corresponding to the initially set dispensing amount per unit time is dispensed while the user inputs the dispensing-start signal. In a case where it is set in step S11 by the user that both of ice and water are dispensed, it can be selected in step S13 that both of ice and water are dispensed in the same automatic or manual mode or in the different automatic or manual mode. That is, in step S13, it can be selected in step S13 by the user that both of ice and water are dispensed in the automatic or manual mode or that one of ice and water is dispensed in the automatic mode but the other is dispensed in the manual mode.

If the automatic mode is selected, the user sequentially operates the dispensing amount-setting button 64 and the dispensing time-setting button 65 to set the dispensing time and amount per unit time of ice, water or both (S15 and S17). Further, the user operates the setting completion button 66 to input the setting completion signal (S119).

Next, the user pushes the operation knob 43 (refer to FIGS. 1 and 2) using an ice container, cup or the like to turn on the switch SW2 and to input the dispensing-start signal (S21). If the switch SW2 is turned on, the control unit 80 drives a motor and/or opens the valve in response to the dispensing-start signal (S23). At this time, the control unit 80 controls a driving rate and time of the motor and/or an opening degree and time of the valve in accordance with the inputted dispensing time and amount per unit time of ice, water or both. In addition, if the motor is driven and/or the valve is opened, ice, water or both are dispensed to the outside through the ice duct 45A and/or the dispensing port 45B (S25).

The control unit 80 decides whether the motor has been driven and/or the valve has been opened for the dispensing time inputted in step S17 (S27). Then, the control unit 80 controls the motor and/or valve such that the motor can be driven and/or the valve can be opened for the dispensing time inputted in step S17 (S29). That is, if it is determined that the motor has been driven and/or the valve has been opened for the dispensing time inputted in step S17, the control unit 80 stops the motor and/or closes the valve.

Unless any one of the dispensing amount per unit time of ice, water or both (S15), the dispensing time of ice, water or both (S17), the setting completion signal (S19) and the dispensing-start signal (S21) is inputted within a predetermined time in steps S15 to S21, the control unit 80 converts the selected automatic mode into the manual mode. Thus, in a state where the user operates the mode-setting button 67 to select the manual mode as described in step S13 or the selected automatic mode is converted into the manual mode by the control unit 80 as described above, the user pushes the operating knob 43 using an ice container, cup or the like to turn on the switch SW2 and to input the dispensing-start signal (S31). Then, the control unit 80 receives the dispensing-start signal from the switch SW2 to drive the motor and/or open the valve (S33). Thus, ice, water or both are dispensed to the outside through the ice duct 45A and/or dispensing port 45B (S35). Further, if the switch SW2 is turned off to complete the input of the dispensing-start signal, i.e. if the user does not push the operating knob 43 any longer using an ice container, cup or the like, the control unit 80 stops the motor and/or closes the valve (S37 and S29).

As described above, if it has been determined in step S11 by the user that both of ice and water are dispensed, it can be selected in step S13 that the ice and water can be dispensed in the same or different mode. Thus, if it has been selected by the user that the ice and water can be dispensed in the mode different from each other, the dispensing of ice and water can be performed in the steps different from each other. For example, if it has been selected in steps S11 and S13 that ice is dispensed in the automatic mode and water is dispensed in the manual mode, the ice is dispensed through steps S15 to S29 and water is dispensed through steps S31 to S37 and the step S29. Therefore, even though the dispensing-start signal is not continuously transmitted to the control unit 80 by not turning on the switch SW2, ice is dispensed through steps S23 to S29 but the dispensing of water is stopped in step S37.

Those skilled in the art can make various changes and modifications thereto without departing from the basic technical spirit of the present invention, and the scope of the present invention should be defined only by the appended claims.

### INDUSTRIAL APPLICABILITY

As described above in detail, an device and method for controlling a dispenser for a refrigerator according to the present invention has the following advantages.

First, ice and water can be dispensed simultaneously or sequentially by only a single operation according to the user's selection. Accordingly, the user can take ice and water more conveniently.

In addition, if the user pushes once an operating knob which turns on a switch through which a dispensing-start signal is inputted, ice and/or water corresponding to a previously set amount can be dispensed. Accordingly, the user can take ice and/or water more conveniently.

1. An device for controlling a dispenser for a refrigerator, comprising:
an input unit for inputting an operation signal to allow ice, water or both to be selectively dispensed through the dispenser; and
a control unit for controlling ice, water or both to be dispensed through the dispenser in response to the operation signal inputted through the input unit.

2. The device as claimed in claim 1, wherein if an operation signal for allowing ice and water to be dispensed is inputted through the input unit, the control unit allows the water and ice to be simultaneously dispensed.

3. The device as claimed in claim 1, wherein if an operation signal for allowing ice and water to be dispensed is inputted through the input unit, the control unit allows the water and ice to be sequentially dispensed.

4. The device as claimed in any one of claims 1 to 3, wherein the operation signal for allowing ice, water or both to be selectively dispensed is inputted through a single or multiple dispensing buttons provided in the input unit.

5. The device as claimed in claim 4, wherein the dispensing button includes:
an ice dispensing button for inputting an operation signal for allowing ice to be dispensed through the dispenser;
a water dispensing button for inputting an operation signal for allowing water to be dispensed through the dispenser; and
an ice/water dispensing button for inputting an operation signal for allowing ice and water to be dispensed through the dispenser.

6. An device for controlling a dispenser for a refrigerator, comprising:
an input unit for inputting a dispensing time and amount per unit time of ice, water or both dispensed through the dispenser; and
a control unit for controlling ice, water or both corresponding to the dispensing amount per unit time inputted through the input unit to be dispensed through the dispenser for the dispensing time inputted through the input unit.

7. The device as claimed in claim 6, wherein a setting completion signal and an operation signal for setting the dispensing time and amount per unit time of ice, water or both are inputted through a dispensing amount-setting button, a dispensing time-setting button and a setting completion button provided on the input unit.

8. The device as claimed in claim 6, wherein the control unit controls a driving rate of a motor for providing a driving force to transfer ice to the dispenser in accordance with the dispensing amount per unit time inputted through the input unit and controls a driving time of the motor in accordance with the dispensing time inputted through the input unit.

9. The device as claimed in claim 6, wherein the control unit controls an opening degree of a valve, through which water is transferred to the dispenser, in accordance with the dispensing amount of water per unit time inputted through the input unit and controls an opening time of the valve in accordance with the dispensing time inputted through the input unit.

10. The device as claimed in claim 6, wherein the control unit receives a dispensing-start signal from a switch provided at a portion of the dispenser when the switch is turned on, and controls the dispensing of ice, water or both through the dispenser to be initiated.

11. The device as claimed in claim 10, wherein the switch is turned on as an operation knob provided at a portion of the dispenser is pushed down.

12. An device for controlling a dispenser for a refrigerator, comprising:
an input unit including a switch for generating a dispensing-start signal to initiate the dispensing of ice, water or both through the dispenser, a dispensing button for inputting an operation signal to allow ice, water or both to be selectively dispensed through the dispenser, and dispensing amount-setting and dispensing time-setting buttons for inputting an operation signal to set a dispensing time and amount per unit time of ice, water or both through the dispenser, respectively; and
a control unit for receiving the dispensing-start signal from the switch and controlling ice, water or both corresponding to the dispensing amount per unit time inputted through the dispensing amount-setting button to be dispensed through the dispenser for the dispensing time inputted through the dispensing time-setting button in response to the operation signal inputted through the dispensing button.

13. The device as claimed in claim 10 or 12, wherein in a case where the dispensing time and amount per unit time of ice, water or both dispensed through the dispenser are inputted through the input unit, the control unit controls the dispenser in an automatic mode in which ice, water or both corresponding to the dispensing amount per unit time inputted through the input unit is dispensed for the dispensing time inputted through the input unit when the dispensing-start signal is transmitted as the switch is turned on; whereas in a case where the dispensing time and amount per unit time of ice, water or both dispensed through the dispenser are not inputted through the input unit, the control unit controls the dispenser in a manual mode in which the selected ice, water or both corresponding to the initially set dispensing amount per unit time is dispensed only a period of time while the dispensing-start signal is transmitted as the switch is turned on.

14. The device as claimed in claim 13, wherein the control unit controls the dispenser in the manual mode except when an operating signal for setting the dispensing time or the dispensing-start signal is inputted through the input unit within a predetermined time in a state where the dispensing amount per unit time of ice, water or both is inputted through the input unit or when the dispensing-start signal is inputted through the input unit within a predetermined time in a state that the dispensing time and amount per unit time of ice, water or both are inputted through the input unit.

15. The device as claimed in claim 10 or 12, wherein the operation signal for selecting one of the manual and automatic modes is inputted through the input unit; and the control unit controls the dispenser either in the automatic mode in which the selected ice, water or both corresponding to the dispensing amount per unit time inputted through the input unit is dispensed for the dispensing time inputted through the input unit when the dispensing-start signal is transmitted as the switch is turned on in a case where an operation signal for selecting the automatic mode is inputted through the input unit or in the manual mode in which the selected ice, water or both corresponding to the initially set dispensing amount per unit time is dispensed only a period of time while the dispensing-start signal is transmitted as the switch is turned on in a case where an operation signal for selecting the manual mode is inputted through the input unit.

16. The device as claimed in claim 15, wherein in a state where the operation signal for selecting the dispensing of water and ice is inputted through the input unit, both of ice and water can be dispensed in the automatic or manual mode or one of the ice and water is dispensed in the automatic mode but the other is dispensed in the manual mode.

17. The device as claimed in claim 15, wherein in a state where an operation signal for selecting the automatic mode is inputted through the input unit, the control unit controls the dispenser in the manual mode except if an additional operation signal is not inputted through the input unit within a predetermined time.

18. The device as claimed in claim 15, wherein an operation signal for selecting any one of the automatic and manual modes is inputted through a mode-setting button provided on the input unit.

19. A method of controlling a dispenser for a refrigerator, comprising the steps of:
(a) inputting an operation signal through an input unit to select the dispensing of ice, water or both;
(b) inputting a dispensing-start signal through the input unit to initiate the dispensing of ice, water or both; and
(c) controlling, by the control unit, the selected ice, water or both to be dispensed through the dispenser in response to the dispensing-start signal received from the input unit.

20. The method as claimed in claim 19, wherein in step (c), when the dispensing of ice and water is selected in step (a), the control unit controls the selected water and ice to be simultaneously dispensed.

21. The method as claimed in claim 19, wherein in step (c), when the dispensing of ice and water is selected in step (a), the control unit controls the selected water and ice to be sequentially dispensed.

22. A method of controlling a dispenser for a refrigerator, comprising the steps of:
(a) inputting an operation signal through an input unit for selecting the dispensing of ice, water or both;
(b) inputting an operation signal through the input unit to set a dispensing time and amount per unit time of ice, water or both; and
(c) controlling, by the control unit, the selected ice, water or both corresponding to the dispensing amount per unit time inputted through the input unit to be dispensed through the dispenser for the dispensing time inputted through the input unit.

23. The method as claimed in claim 22, wherein step (b) comprises the steps of:
(b1) inputting an operation signal through the input unit to set the dispensing amount per unit time of ice, water or both;
(b2) inputting an operation signal through the input unit to set the dispensing time of ice, water or both; and
(b3) inputting an operation signal through the input unit to complete the setting of the dispensing time and amount per unit time of ice, water or both.

24. The method as claimed in claim 22, wherein step (c) comprises the steps of:
(c1) inputting an operation signal through the input unit to generate a dispensing-start signal; and
(c2) controlling, by the control unit, the selected ice, water or both corresponding to the dispensing amount per unit time inputted through the input unit to be dispensed through the dispenser for the dispensing time inputted through the input unit in response to the dispensing-start signal received from the input unit.

25. The method as claimed in claim 24, wherein, in step (C2), the control unit controls a driving rate of a motor for providing a driving force to transfer ice to the dispenser in accordance with the dispensing amount of ice per unit time inputted through the input unit and controls a driving time of the motor in accordance with the dispensing time inputted through the input unit.

26. The method as claimed in claim 24, wherein in step (C2), the control unit controls an opening degree of a valve, through which water is transferred to the dispenser, in accordance with the dispensing amount of water per unit time inputted through the input unit and controls an opening time of the valve in accordance with the dispensing time inputted through the input unit.

27. The method as claimed in claim 24, wherein in step (c2), the control unit controls the dispenser either in the automatic mode in which the selected ice, water or both corresponding to the dispensing amount per unit time inputted through the input unit is dispensed for the dispensing time inputted through the input unit when the dispensing-start signal is transmitted in a case where the dispensing time and amount per unit time of ice, water or both are inputted through the input unit within a predetermined time, or in the manual mode in which the ice, water or both corresponding to the initially set dispensing amount per unit time is dispensed only a period of time while the dispensing-start signal is transmitted from the input unit except in a case where the dispensing time and amount per unit time of ice, water or both are inputted through the input unit within the predetermined time.

28. A method of controlling a dispenser for a refrigerator, comprising the steps of:
(a) inputting an operation signal through an input unit to select the dispensing of ice, water or both;
(b) inputting an operation signal through the input unit to select any one of automatic and manual modes;
(c) inputting a dispensing time and amount per unit time of ice, water or both through the input unit; and
(d) controlling the dispenser, by the control unit, such that in a case where an operation signal for selecting the automatic mode is inputted through the input unit, the selected ice, water or both corresponding to the dispensing amount per unit time inputted through the input unit is dispensed for the dispensing time inputted through the input unit when the dispensing-start signal is transmitted from the input unit, or that the selected ice, water or both corresponding to the initially set dispensing amount per unit time is dispensed only a period of time while the dispensing-start signal is transmitted in a case where an operation signal for selecting the manual mode is inputted through the input unit.

29. The method as claimed in claim 28, wherein in step (b), in a case where the operation signal for selecting the dispensing of water and ice is inputted through the input unit, both of ice and water can be dispensed in the automatic or manual mode or one of the ice and water is dispensed in the automatic mode but the other is dispensed in the manual mode.

30. The method as claimed in claim 28, wherein step (c) comprises the steps of:
(c1) inputting an operation signal through the input unit to set the dispensing amount per unit time of ice, water or both;
(c2) inputting an operation signal through the input unit to set the dispensing time of ice, water or both; and
(c3) inputting an operation signal through the input unit to complete the setting of the dispensing time and amount per unit time of ice, water or both.

31. The method as claimed in claim 28, wherein step (d) comprises the steps of:
(d1) inputting an operation signal through the input unit to generate a dispensing-start signal; and
(d2) controlling the dispenser, by the control unit, such that in a case where an operation signal is inputted through the input unit to select the automatic mode, the selected ice, water or both corresponding to the dispensing amount per unit time inputted through the input unit is dispensed through a dispenser for the dispensing time inputted through the input unit when the dispensing-start signal is transmitted from the input unit or that the selected ice, water or both corresponding to the initially set dispensing amount per unit time is dispensed through the dispenser only for a period of time while an operating signal is inputted through the input unit to generate the dispensing-start signal in a case where an operation signal is inputted through the input unit to select the manual mode.

32. The method as claimed in claim 31, wherein step (d) further comprises the step of (d3) controlling the dispenser in the manual mode by the control unit except in a case where the dispensing time and amount per unit time of ice, water or both are inputted through the input unit within a predetermined time, when the operation signal is inputted through the input unit to select the automatic mode.
